(19) United States
(12) Patent Application Publication
(10) Pub. No.: US 2015/0360613 A1
(43) Pub. Date: Dec. 17, 2015

(54) APPARATUS AND METHOD FOR IDENTIFYING LOCATION OF VEHICLES

(71) Applicant: Hyundai Mobis Co., Ltd., Seoul (KR)

(72) Inventor: Seong Soo LEE, Yongin-si (KR)

(21) Appl. No.: 14/706,588

(22) Filed: May 7, 2015

(30) Foreign Application Priority Data
Jun. 13, 2014 (KR) 10-2014-0072288

(51) Int. Cl. B60R 1/00; G06K 9/18

(52) U.S. Cl. CPC B60R 1/00; G06K 9/18; B60R 2300/10; B60R 2300/303; B60R 2300/60; B60R 2300/806

(57) ABSTRACT

An apparatus for identifying the location of vehicles includes a camera module continuously photographing peripheral images of a vehicle, an AVM module displaying the peripheral images and an AVM image generated based on the peripheral images, and a control module distinguishing each of the peripheral images and the AVM image as a text recognition image and a text non-recognition image. It updates and stores the distinguished peripheral images and AVM image. When the vehicle is turned off, the control module transmits the text recognition image and the text non-recognition image stored before the turn-off to a predetermined mobile terminal.

### CROSS-REFERENCE TO RELATED APPLICATION

The present application claims priority from and the benefit of Korean Patent Application Number 10-2014-0072288, filed Jun. 13, 2014, the entire contents of which application is incorporated herein for all purposes by this reference.

### BACKGROUND

1. Field

Exemplary embodiments relate to an apparatus and a method for identifying the location of vehicles. More particularly, exemplary embodiments relate to an apparatus and a method for identifying the location of vehicles, which allow a vehicle driver to easily identify a parking location by transmitting a text recognition image and a text non-recognition image photographed before turn-off at the time of turning off a vehicle to a mobile terminal.

2. Discussion of the Background

As the number of vehicles on the street increases, public facilities, such as airports, huge shopping centers, department stores, parks, and huge recreational centers, have more outdoor and indoor parking spaces of huge size. Due to a huge size as well as similarity of each lot of the large parking lots, customers find it difficult to his/her own vehicle.

Various techniques for finding a parking location in the related art were developed. In this regard, wireless communication is not easy to keep open due to a weak radio signal identifying the location of the vehicle or a mobile device. As a result, image data cannot not be transmitted. Further, continuous operation of a telematics module in the vehicle for remote access to the mobile device consumes battery power rapidly.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an apparatus and a method for identifying the location of vehicles, which allows a user to identify a parking location by updating and storing a text recognition image and a text non-recognition image based on a vehicle and its surrounding image taken at the time of parking the vehicle and transmitting the recently updated text recognition image and text non-recognition image to a mobile terminal set by the user when the user turned off the vehicle after parking the vehicle.

Additional aspects will be set forth in the detailed description which follows, and, in part, will be apparent from the disclosure, or may be learned by practice of the inventive concept.

According to exemplary embodiments, an apparatus for identifying the location of vehicles includes: a camera module continuously photographing peripheral images of a vehicle; an Around View Monitoring (AVM) module displaying the peripheral images and an AVM image generated based on the peripheral images; and a control module distinguishing each of the peripheral images and the AVM image as a text recognition image and a text non-recognition image according to recognition of a text to update and store the distinguished peripheral images and AVM image, and when the vehicle is turned off, the control module controls the text recognition image and the text non-recognition image stored before the turn-off to be transmitted to a predetermined mobile terminal.

The apparatus may further include a communication module transmitting the text recognition image and the text non-recognition image to the mobile terminal according to the control of the control module.

The control module may include a text recognition unit recognizing a text including figures in the peripheral images and the AVM image, a storage unit distinguishing the peripheral images and the AVM image as the text recognition image and the text non-recognition image according to the text recognition of the text recognition unit to update and store the distinguished peripheral images and AVM image, and a control unit determining whether the vehicle is turned off and controls, when the vehicle is turned off, the text recognition image and the text non-recognition image stored in the storage unit to be transmitted to the mobile terminal.

The storage unit may store image information corresponding to the text recognition image and the text non-recognition image, respectively.

The image information may include at least one of an image acquisition time and image format information.

The camera module may include a front camera photographing a front image of the vehicle in the peripheral images, a rear camera photographing a rear image of the vehicle in the peripheral images, and side cameras photographing left and right images of the vehicle in the peripheral images.

Each of the text recognition image and the text non-recognition image may include the front image, the rear image, and the AVM image.

The AVM module may generate the AVM image acquired by synthesizing the front image, the rear image, the left image, and the right image according to a predetermined reference.

According to exemplary embodiments, a method for identifying the location of vehicles includes: photographing peripheral images of a vehicle by actuating a camera module; generating, by an AVM module, an AVM image based on the peripheral images and displaying the peripheral images and the AVM image; distinguishing each of the peripheral images and the AVM image as a text recognition image and a text non-recognition image according to recognition of a text to store the distinguished peripheral images and AVM image; and transmitting, when the vehicle is turned off, the text recognition image and the text non-recognition image stored before the turn-off to be transmitted to a predetermined mobile terminal.

The storing may include recognizing a text including figures in the peripheral images and the AVM image, and distinguishing the peripheral images and the AVM image as the text recognition image and the text non-recognition image according to the text recognition to update and store the distinguished peripheral images and AVM image.

In the storing, image information corresponding to the text recognition image and the text non-recognition image, respectively may be stored.

The image information may include at least one of an image acquisition time and image format information.

According to exemplary embodiments, an apparatus and a method for identifying the location of vehicles can identify a location where a vehicle is parked to easily find the vehicle by transmitting an image including a text of the location where the vehicle is parked and an image not including the text to a set mobile terminal based on a peripheral image of the vehicle and an AVM image generated based on the peripheral image at the time of parking the vehicle.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a control block diagram illustrating a control configuration of an apparatus for identifying the location of vehicles according to the present invention.

FIG. 2 is a flowchart illustrating a method for identifying the location of vehicles according to the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

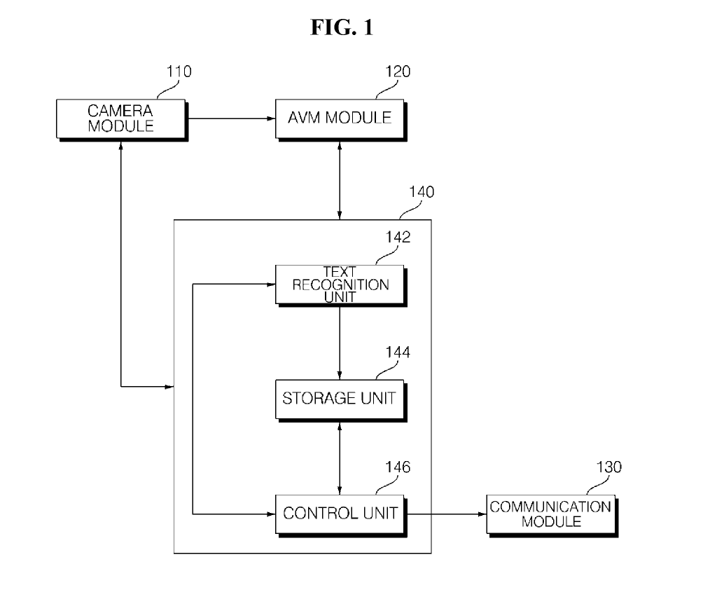

FIG. 1 is a control block diagram illustrating a control configuration of an apparatus for identifying the location of vehicles.

Referring to FIG. 1, the apparatus for identifying the location of vehicles may include a camera module 110, an Around View Monitoring (AVM) module 120, a communication module 130, and a control module 140.

The control module 140 operates the camera module 110 depending on the speed or transmission gear combination of a vehicle to photograph images around the vehicle.

Herein, the camera module 110 may include a front camera (not shown) photographing a front image of the vehicle in the peripheral images, a rear camera (not shown) photographing a rear image of the vehicle in the peripheral images, and side cameras (not shown) photographing right and left images of the vehicle in the peripheral images.

That is, the control module 140 controls the camera module 110 to continuously take picture of the surroundings of the vehicle.

The AVM module 120 may monitor surroundings of the vehicle to park the vehicle easily.

Herein, the AVM module 120 may work together with the camera module 110 and display the peripheral images and an AVM image acquired by generating the peripheral images according to a predetermined reference.

That is, the AVM module 120 may generate the AVM image by synthesizing the front image, the rear image, the right image, and the left image of the vehicle according to the predetermined reference and display the peripheral images and the AVM image.

Thereafter, the AVM module 120 may continuously transfer the displayed peripheral images and AVM image to the control module 140.

The control module 140 may communicate them with a mobile terminal set through the communication module 130.

The control module 140 may include a text recognition unit 142, a storage unit 144, and a control unit 146.

In the exemplary embodiment, it is described that the control module 140 receives the peripheral images and the AVM image from the AVM module 120. However, the control module 140 may receive the peripheral images from the camera module 110 and receive the AVM image from the AVM module 120 and the present invention is not limited thereto.

The text recognition unit 142 may analyze the images and recognize a text including figures and letters from the peripheral images and the AVM image provided by the AVM module 120 or the camera module 110.

More specifically, the text recognition unit 142 may recognize the text included in the peripheral images and the AVM image, puts the images with texts as the text recognition image, and puts the images without texts as a text non-recognition image.

The storage unit 144 may update and store the text recognition image and the text non-recognition image sorted by the text recognition unit 142 with time stamps.

In this case, the storage unit 144 may store image information including the information corresponding to the text recognition image and the text non-recognition image, respectively.

The image information may include at least one of a time stamp and a format information of the image. For example, the text recognition image and the text non-recognition image may be stored as compressed images by JPEG standard, and the like and the text recognition image and the text non-recognition image may store an image information name such as “2014-07-01-1451_FO.jpg” according to the standard. In this case, ‘2014-07-01’ means an image acquisition date, and ‘1451’ means that the image acquisition time is 02:51 PM, ‘F’ means the front image in the peripheral images, and ‘O’ means the text recognition image.

When the image information name is “2014-07-01-1415_RX.jpg”, ‘R’ means the rear image in the peripheral images and ‘X’ means the text non-recognition image.

As such, the storage unit 144 may store the image information with its name that distinguished the text recognition image and the text non-recognition image. However, the present invention is not limited thereto.

The control unit 146 checks whether the vehicle is turned off. When the vehicle is turned off, the control unit 146 may extract the most recently stored text recognition image and text non-recognition image and transmit them to the mobile terminal through the communication module 130.

In this case, when the communication module 130 is not able to communicate with the mobile terminal, the control unit 146 may notify by itself so that a user can recognize the text by using an acoustic device such as a speaker of the vehicle, and the like.

When the vehicle is turned off, the control unit 146 may operate by getting power from a battery in the vehicle for a predetermined time. And the present invention is not limited thereto.

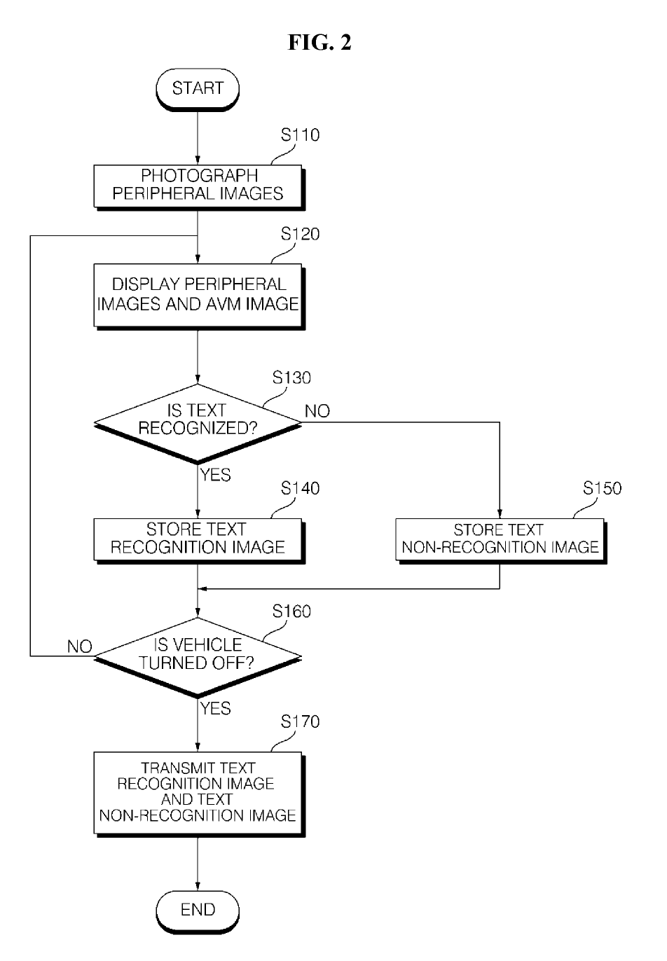

FIG. 2 is a flowchart illustrating a method for identifying the location of vehicles according to the present invention.

FIG. 2 is described based on the apparatus for identifying the location of vehicles illustrated in FIG. 1.

Referring to FIG. 2, in the method for identifying the location of vehicles, the camera module 110 photographs the peripheral images of the vehicle according to the control of the control module 140 (S110).

That is, the control module 140 actuates the camera module 110 according to the speed and a gear state of the vehicle to photograph the peripheral images of the vehicle, that is, the front image, the rear image, the right image, and the left image. For example, when the control module 140 recognizes as the vehicle is in a parking state, the control module 140 may activate the camera module 110

The AVM module 120 displays the AVM image generated based on the peripheral image photographed by the camera module 110 and the peripheral images (S120).

That is, the AVM module 120 generates the AVM image based on the peripheral images transferred from the camera module 110 according to the predetermined reference and displays the AVM image and the peripheral images.

The control module 140 recognizes a text including figures and letters in the AVM image and the peripheral images transferred from the AVM module 120.

The control module 140 distinguishes the AVM image and the peripheral images in which the text is recognized as the text recognition image and stores the AVM image and the peripheral images like the image information or the image information name in the storage unit 144 (S140) and distinguishes the AVM image and the peripheral images in which the text is not recognized as the text non-recognition image and stores the AVM image and the peripheral images like the image information or the image information name in the storage unit 144 (S150).

The control module 140 determines whether the vehicle is turned off (S160) and when the vehicle is turned off, the control module 140 transmits the text recognition image and the text non-recognition image to the mobile terminal through the communication module 130 according to a predetermined standard (S170) and when the vehicle is not turned off, the process proceeds to step S120.

Unless explicitly described otherwise, a term “including”, “comprising”, or “having” disclosed hereinabove any components will be understood to imply the inclusion of other components but not the exclusion but further inclusion of any other components.

While the exemplary embodiments of the present invention have been illustrated and described above, the present invention is not limited to the aforementioned specific exemplary embodiments, various modifications may be made by a person with ordinary skill in the art to which the present invention pertains without departing from the subject matters of the present invention that are claimed in the claims, and these modifications should not be appreciated individually from the technical spirit or prospect of the present invention.

What is claimed is:

1. An apparatus for identifying the location of vehicles, comprising:
a camera module photographing peripheral images of a vehicle;
an Around View Monitoring (AVM) module generating AVM images by synthesizing a front image, a rear image, a right image, and a left image of the vehicle; and
a control module distinguishing each of the peripheral images and the AVM image as a text recognition image and a text non-recognition image,
wherein the control module transmits the text recognition image and the text non-recognition image stored most recently to a mobile terminal, once the vehicle is turned off.

2. The apparatus of claim 1, further comprising:
a communication module transmitting the text recognition image and the text non-recognition image to the mobile terminal.

3. The apparatus of claim 1, wherein the control module includes:
a text recognition unit recognizing a text including figures from the peripheral images and the AVM images;
a storage unit storing the text recognition image and the text non-recognition image distinctively; and
a control unit that checks whether the vehicle is turned off or not.

4. The apparatus of claim 3, wherein the storage unit stores image information corresponding to the text recognition image and the text non-recognition image, respectively.

5. The apparatus of claim 4, wherein the image information includes at least one of an image acquisition time and image format information.

6. The apparatus of claim 1, wherein the camera module includes:
a front camera photographing a front image of the vehicle;
a rear camera photographing a rear image of the vehicle; and
side cameras photographing a left image and a right image of the vehicle.

7. The apparatus of claim 6, wherein each of the text recognition image and the text non-recognition image includes the front image, the rear image, and the AVM image.

8. The apparatus of claim 6, wherein the AVM module generates the AVM image acquired by synthesizing the front image, the rear image, the left image, and the right image.

9. A method for identifying the location of vehicles, comprising:
photographing peripheral images of a vehicle;
generating an Around View Monitoring (AVM) image based on the peripheral images and displaying the peripheral images and the AVM image;
sorting and storing a text recognition image and a text non-recognition image from each of the peripheral images and the AVM image; and
transmitting the text recognition image and the text non-recognition image stored most recently to a mobile terminal, once the vehicle is turned off.

10. The method of claim 9, wherein the step of sorting and storing further includes:
recognizing a text including figures from the peripheral images and the AVM image; and
distinguishing the text recognition image and the text non-recognition image from the peripheral images and the AVM image.

11. The method of claim 9, wherein image information on the text recognition image and the text non-recognition image is stored respectively, during the step of sorting and storing.

12. The method of claim 11, wherein the image information includes at least one of an image acquisition time and an image format information.
